(19) United States
(12) Patent Application Publication
(10) Pub. No.: US 2025/0117565 A1
(43) Pub. Date: Apr. 10, 2025

(54) DESIGN ASSISTANCE DEVICE, LEARNING DEVICE AND NON-TRANSITORY COMPUTER READABLE STORAGE MEDIUM

(71) Applicant: Mitsubishi Electric Corporation, Chiyoda-ku, Tokyo (JP)

(72) Inventors: Kazuhiro KOBAYASHI, Chiyoda-ku, Tokyo (JP); Satoru ISHIZAKA, Chiyoda-ku, Tokyo (JP)

(73) Assignee: Mitsubishi Electric Corporation, Chiyoda-ku, Tokyo (JP)

(21) Appl. No.: 18/833,218

(22) PCT Filed: Feb. 24, 2023
(86) PCT No.: PCT/JP2023/006699

§ 371 Date: Jul. 25, 2024

(30) Foreign Application Priority Data
Mar. 8, 2022 (JP) 2022-035197

(51) Int. Cl. G06F 30/398

(52) U.S. Cl. CPC G06F 30/398

(57) ABSTRACT

A design assistance device includes: a database unit to store reference information associating feature information which includes a shape of a component comprising an electronic circuit board with type information of the component; a data input unit to receive an input of design data of a target electronic circuit board to be subjected to design rule checking; an extraction unit to extract feature information which includes shape information of a component comprising the target electronic circuit board; a determination unit to determine type information, corresponding to the extracted feature information, of the component comprising the target electronic circuit board, based on the extracted feature information and the reference information; a generation unit to generate new design data by adding the type information determined by the determination unit to the design data; and a check execution unit to perform the design rule checking on the new design data.

### TECHNICAL FIELD

The present disclosure relates to a design assistance device and a learning device.

### BACKGROUND ART

In recent years, the circuit board mounted on an electronic device is densified with an enhancement of the electronic device, increasing the number of integrated circuits (ICs) mounted on the circuit board and increasing the types of integrated circuits. This increases the design burden, requiring an increase in efficiency of the substrate design such as a substrate design check. As an increase in efficiency of the substrate design, a substrate design rule checking functionality is known, which is provided in a computer aided design (CAD) device or the like that is used to design a circuit board. The design rule checking functionality checks whether a designed circuit board meets design rules for EMC performance, for example.

WO2020/079810 (PTL 1) discloses a design assistance device. The design assistance device performs design rule checking on design data through geometrical computations, generates, from the design data, image data in which a portion determined to be an error is centered, performs design rule checking on the image data by artificial intelligence, and displays a result of the design rule checking.

### CITATION LIST

### Patent Literature

PTL 1: WO2020/079810

### SUMMARY OF INVENTION

### Technical Problem

An electronic circuit board is configured of various types of components (e.g., an IC package, an interconnect pattern, etc.), the design rule checking, therefore, needs to be performed based on design constraints depending on a type of each component. Therefore, if electronic circuit board design data includes no information indicating a type of each component, appropriate design rule checking cannot be performed on each component. PTL 1 considers increasing, with the above-described configuration, the efficiency in work to check whether the error determined by the design rule checking is a true error or not, but fails to teach or suggest any solution to the above problem.

An object of a certain aspect according to the present disclosure is to provide a technique that allows appropriate design rule checking to be performed on a component comprising an electronic circuit board.

### Solution to Problem

A design assistance device according to a certain embodiment includes: a database unit to store reference information associating feature information which includes a shape of a component comprising an electronic circuit board with type information of the component; a data input unit to receive an input of design data of a target electronic circuit board to be subjected to design rule checking; an extraction unit to extract feature information which includes shape information of a component comprising the target electronic circuit board by analyzing the design data; a determination unit to determine type information, corresponding to the extracted feature information, of the component comprising the target electronic circuit board, based on the extracted feature information and the reference information stored in the database unit; a generation unit to generate new design data by adding the type information determined by the determination unit to the design data; and a check execution unit to perform the design rule checking on the new design data.

A learning device according to another embodiment includes: a data acquisition unit to obtain learning data which includes: feature information which includes a shape of a component comprising an electronic circuit board; and specification information of the electronic circuit board; and a model generation unit to generate, using the learning data, a learned model for estimating type information of the component comprising the electronic circuit board from the feature information and the specification information.

A design assistance device according to still another embodiment includes: a data input unit to receive an input of design data of a target electronic circuit board to be subjected to design rule checking; an extraction unit to extract feature information which includes a shape of a component comprising the target electronic circuit board, and specification information of the target electronic circuit board, by analyzing the design data; and an estimation unit to estimate type information of the component by inputting the feature information and the specification information extracted by the extraction unit to a learned model for estimating the type information from the feature information and the specification information.

### Advantageous Effects of Invention

According to the present disclosure, design rule checking depending on a component comprising an electronic circuit board.

### BRIEF DESCRIPTION OF DRAWINGS

FIG. 1 is a diagram showing one example of a hardware configuration of a design assistance device.

FIG. 2 is a block diagram showing a functional configuration example of a design assistance device according to Embodiment 1.

FIG. 3 is a diagram showing a symbol figure example of an IC package.

FIG. 4 is a diagram showing one example of an information table of the IC package.

FIG. 5 is a diagram showing an updated version of the information table of the IC package of FIG. 4.

FIG. 6 is a diagram for illustrating a sequence to identifying IC package names.

FIG. 7 is a diagram showing one example of an interconnect pattern connected to terminals of the IC package.

FIG. 8 is a diagram showing one example of an information table of the interconnect pattern.

FIG. 9 is a diagram showing an updated version of the information table of the interconnect pattern of FIG. 8.

FIG. 10 is a block diagram showing a functional configuration example of a design assistance device according to Embodiment 2.

FIG. 11 is a flowchart illustrating one example of a learning process of the design assistance device.

FIG. 12 is a flowchart illustrating one example of process steps performed by the design assistance device.

FIG. 13 is a diagram showing one example of an information table of an IC package according to other embodiment.

FIG. 14 is a diagram for illustrating a positional relationship between the IC package and peripheral circuit parts.

FIG. 15 is a diagram for illustrating a mode of application of a threshold during ongoing design rule checking.

### DESCRIPTION OF EMBODIMENTS

Hereinafter, embodiments are described, with reference to the accompanying drawings. In the following description, like reference signs refer to like parts. Their names and functionalities are also the same. Thus, detailed description thereof will not be repeated.

### Embodiment 1

A design assistance device according to the present embodiment has a functionality to perform design rule checking on design data (e.g., CAD data) of an electronic circuit board (e.g., a printed circuit board) having circuit elements arranged thereon. In the following, a configuration, processing, etc. of a design assistance device 100 will be described in detail.

### <Hardware Configuration>

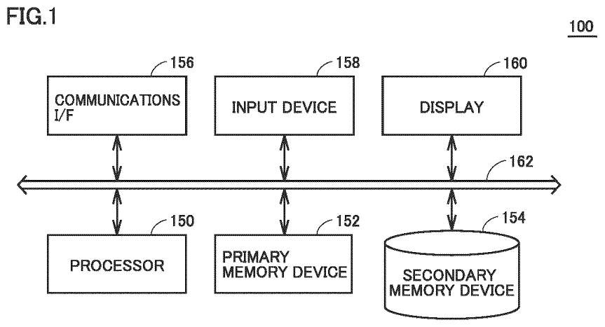

FIG. 1 is a diagram showing one example of a hardware configuration of the design assistance device 100. The design assistance device 100 is mainly configured of a microcomputer. Specifically, the design assistance device 100 includes a processor 150, a primary memory device 152, a secondary memory device 154, a communications interface 156, an input device 158, and a display 160, which are communicatively connected to each other via an internal bus 162.

The processor 150 is, typically, an arithmetic processing unit such as a central processing unit (CPU) or multi-processing unit (MPU), reads various programs, including an operating system (OS) installed in the secondary memory device 154, deploys the programs for execution on the primary memory device 152.

The primary memory device 152 is, typically, a volatile storage medium such as a DRAM (dynamic random access memory), and maintains various work data that are necessary to execute various programs, in addition to codes of the various programs, including the OS, executed by the processor 150. The secondary memory device 154 is a nonvolatile storage medium such as a hard disk or an SSD (Solid State Drive), and maintains various settings values, in addition to the various programs, including the OS.

The communications interface 156 mediates data transmission between the processor 150 and an external device. The communications via the communications interface 156 are performed, using the Internet, a wide area network (WAN), a local area network (LAN), an Ethernet (registered trademark) network, a wired or wireless network, or a combination thereof.

The input device 158 receives an operation input to the design assistance device. The input device 158 is implemented in, for example, a keyboard, button, mouse, touch panel, etc.

The display 160 is, for example, a liquid crystal display, an organic EL (Electro Luminescence) display, etc. The display 160 may be integrated with the design assistance device 100 or configured separately from the design assistance device 100.

Note that, unlike the example of FIG. 1, at least part of the design assistance device 100 can be configured, using circuits such as a field programmable gate array (FPGA) and an application specific integrated circuit (ASIC).

### <Functional Configuration>

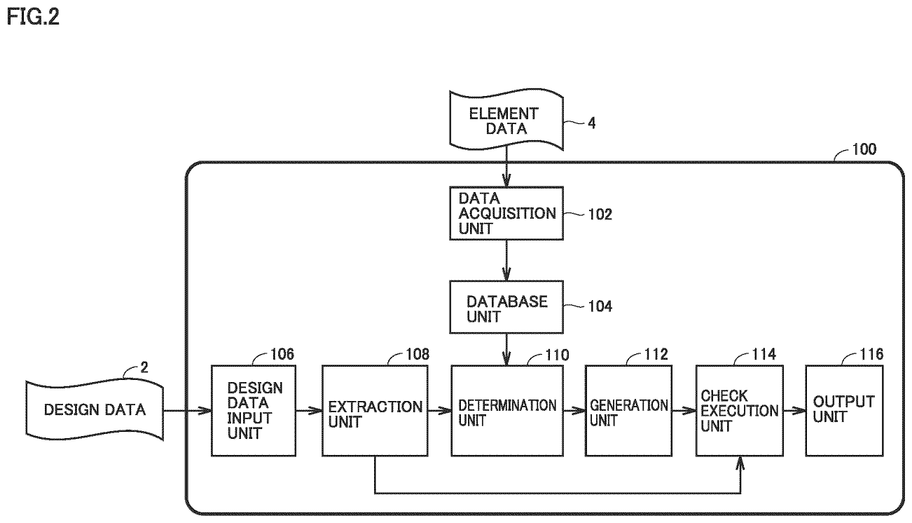

FIG. 2 is a block diagram showing a functional configuration example of the design assistance device according to Embodiment 1. Referring to FIG. 2, the design assistance device 100 includes a data acquisition unit 102, a database unit 104, a design data input unit 106, an extraction unit 108, a determination unit 110, a generation unit 112, a check execution unit 114, and an output unit 116. The database unit 104 is implemented by the primary memory device 152 or the secondary memory device 154. Typically, each functionality, other than that of the database unit 104, is implemented by the processor 150 executing a program, but may be implemented by a dedicated hardware circuit.

The data acquisition unit 102 obtains element data 4 related to each component comprising the electronic circuit board (e.g., receives an input of the element data 4). The element data 4 includes IC-related information that is related to an IC included in the electronic circuit board, pattern-related information that is related to an interconnect pattern in the electronic circuit board, and the specification information of the electronic circuit board (e.g., including the product application of the electronic circuit board, the amount of a current, etc.).

The IC-related information includes package feature information that is related to features of the IC package, and package type information indicating a type of the IC package. The package feature information includes the outline shape of the IC package (e.g., the number of sides of the outline), a terminal shape of the IC package (e.g., rectangular, round, etc.), and the terminal position information (e.g., information indicating the positional relationship between the package outline and the terminals). The package type information includes an IC package name such as ball grid array (BGA), quad flat non-leaded package (QFN), small outline package (SOP), quad flat package (QFP), etc.

The pattern-related information includes pattern feature information indicating characteristics of the interconnect pattern, and pattern type information indicating a type of the interconnect pattern. The pattern feature information includes a material of the interconnect pattern, the relative permittivity of a circuit board provided with the interconnect pattern, the layer configuration of the circuit board, an impedance value of the interconnect pattern, an interconnect pattern geometry (e.g., length, width, figure), a ratio of a maximum width of the interconnect pattern connected to a terminal of the IC package to a dimension of the terminal. The pattern type information includes name (or application) information of the interconnect pattern such as Signal (a signal pattern), VCC (a power supply pattern), GND, etc.

The database unit 104 accumulates various element data 4 input to the data acquisition unit 102. Specifically, the database unit 104 stores reference information that associates the feature information (e.g., the package feature information and the pattern feature information), including the shape of a component comprising the electronic circuit board, with the type information (e.g., the package type information and the pattern type information) of the component.

The database unit 104 stores, as the reference information, a table R1 that associates the package feature information (e.g., the outline shape of the IC package, the terminal shape of the IC package, and the terminal position information) with the package type information. The table R1 is data that is referred to by a determination unit 110 described below.

The database unit 104 stores a table R2 that associates the pattern feature information with the pattern type information. For example, the table R2 includes a ratio of a maximum width of the interconnect pattern to the terminal dimension of the IC package and a list and distribution of impedance values of interconnect pattern values, in the signal pattern. Similarly, the table R2 includes the ratio, and a list and distribution of the impedance values, in the power supply pattern.

The design data input unit 106 receives an input of the design data 2 of a target electronic circuit board to be subjected to the design rule checking. Typically, the design data 2 is CAD data of the target electronic circuit board.

By analyzing the design data 2, the extraction unit 108 extracts the feature information which includes the shape of a component comprising the target electronic circuit board. Initially, the extraction unit 108 determines whether the design data 2 includes the type information (e.g., the package type information, the pattern type information) of the component comprising the target electronic circuit board. The package type information and the pattern type information are information that are required to perform the design rule checking depending on these types. Stated differently, the extraction unit 108 determines whether the design data 2 lacks the information for the design rule checking to be properly performed.

For example, if the package information entry field in an IC library is empty in the design data 2, or a defined package name (e.g., BGA, QFN) is not entered in the package information entry field (e.g., just a string of numbers or the like), the extraction unit 108 determines that the design data 2 includes no package type information. If a defined package name is entered in the package information entry field, in contrast, the extraction unit 108 determines that the design data 2 includes package type information.

If a net attribute entry field for net data of the design data 2 is empty, or a defined pattern name (e.g., VCC, GND, Signal) is not entered in the net attribute entry field (e.g., just a string of numbers or the like), the extraction unit 108 determines that the design data 2 includes no pattern type information. If a defined pattern name is entered in the net attribute entry field, in contrast, the extraction unit 108 determines that the design data 2 includes pattern type information.

If the extraction unit 108 determines, with the above manner, that the design data 2 includes no type information of a component comprising the target electronic circuit board, the extraction unit 108 extracts the feature information of the component. In a certain aspect, as the package feature information, the extraction unit 108 extracts the outline shape of the IC package, the terminal shape of the IC package, and the information indicating the positional relationship between the outline of the IC package and the terminals of the IC package (i.e., the terminal position information). In other aspect, as the pattern feature information, the extraction unit 108 extracts the ratio of a maximum width (i.e., a maximum pattern width) of the interconnect pattern connected to the terminals of the IC package included in the target electronic circuit board to the terminal dimension of the IC package, and the impedance value of the interconnect pattern. Note that a specific method of extraction of the feature information by the extraction unit 108 will be described below.

Based on the feature information extracted by the extraction unit 108 and the reference information (e.g., the tables R1 and R2) stored in the database unit 104, the determination unit 110 determines the type information, of the component comprising the target electronic circuit board, which corresponds to the extracted feature information. Specifically, the determination unit 110 determines the package type information (e.g., BGA, QFN) corresponding to the package feature information by comparing the extracted package feature information with the table R1. The determination unit 110 also determines the pattern type information (e.g., the signal pattern, the power supply pattern) corresponding to the pattern feature information by comparing the extracted pattern feature information with the table R2.

The generation unit 112 generates new design data by adding the type information determined by the determination unit 110 to the design data 2.

The check execution unit 114 performs the design rule checking on the new design data generated by the generation unit 112. Specifically, the check execution unit 114 performs, on the new design data, the design rule checking depending on the added package type information and pattern type information.

Note that if the extraction unit 108 determines that the design data 2 includes the type information of the component comprising the target electronic circuit board, the design data 2 obtained by the design data input unit 106 is input to the check execution unit 114. In this case, the feature information extraction process by the extraction unit 108, the type information determination process by the determination unit 110, and the process adding the type information to the design data 2 by the generation unit 112 are not performed. Accordingly, the check execution unit 114 performs the design rule checking on the design data 2 obtained by the design data input unit 106.

The output unit 116 outputs a result of the design rule checking by the check execution unit 114. For example, the output unit 116 shows the result of the design rule checking on the display 160, or transmits the result of the design rule checking to an external device.

### <Package Type Determination Scheme>

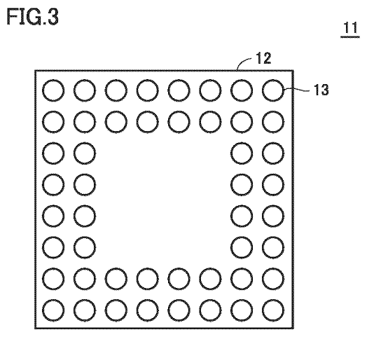

FIG. 3 is a diagram showing a symbol figure example of the IC package.

Referring to FIG. 3, the extraction unit 108 extracts a rectangular shape that has the longest diagonal line among a group of figures constituting the symbol figure of an IC package 11, as an outline 12 for the IC package 11 (i.e., extracts the outline shape for the IC package). Among the group of figures constituting the symbol figure of the IC package 11, the extraction unit 108 extracts multiple figures, other than the outline 12, as terminals 13 of the IC package 11 (i.e., extract the terminal shape of the IC package). The extraction unit 108 extracts information indicating the positional relationship between the outline 12 of the IC package and the terminals 13 (i.e., the terminal position information). The terminal position information includes information whether the terminals 13 are present inside or outside a closed area demarcated by the outline 12. Based on these extracted information, the package type information is determined.

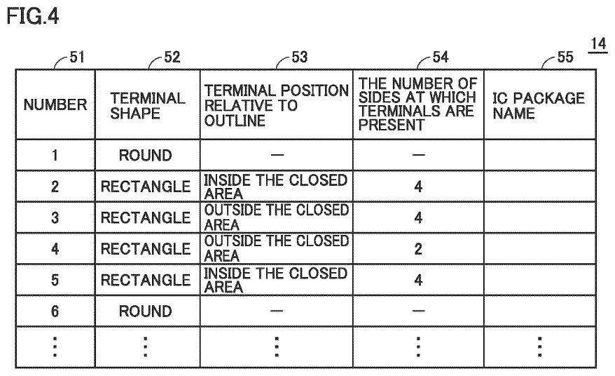

FIG. 4 is a diagram showing one example of an information table of the IC package. Referring to FIG. 4, in an information table 14, part numbers are shown in a column 51, terminal shapes are shown in a column 52, terminal positions relative to the outline (hereinafter, referred to also as “terminal positions”) are shown in a column 53, the numbers of sides of the IC package outline at which the terminals are present (hereinafter, referred to also as “the number of sides”) are shown in a column 54, and IC package names are shown in a column 55. The information table 14 consists of these five items. The terminal position “inside the closed area” indicates that the terminals are present inside the closed area demarcated by the outline. The terminal position “outside the closed area” indicates that the terminals are present outside the closed area.

The terminal shapes in the column 52, the terminal positions in the column 53, and the numbers of sides in the column 54 correspond to the feature information of the IC package extracted by the extraction unit 108. The IC package names in the column 55 correspond to the package type information determined by the determination unit 110 based on the feature information of the IC package. Note that the part numbers in the column 51 are extracted from the design data 2 (e.g., extracted by reading the text information described on the CAD data).

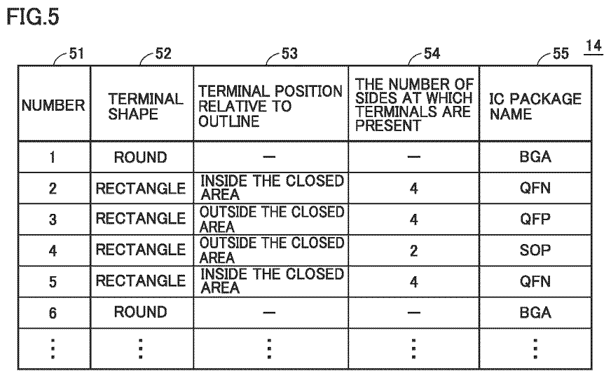

FIG. 5 is a diagram showing an updated version of the information table of the IC package of FIG. 4. The column 55 in the information table 14 of FIG. 5 is updated from the information table 14 of FIG. 4. Specifically, it can be seen that despite of the column 55 in the information table 14 of FIG. 4 being empty, IC package names are described in the column 55 of the information table 14 of FIG. 5.

The determination unit 110 determines the IC package names in the column 55, using the table R1 that associates the package feature information (e.g., the outline shape of the IC package, the terminal shape of the IC package, and the terminal position information) with the package type information. Specifically, the determination unit 110 determines the IC package names in the column 55 by comparing the information in the columns 52, 53, and 54 of the information table 14 with the table R1 stored in the database unit 104. The table R1 is searched for the same feature information as the feature information in the columns 52, 53, and 54, and the package type information that are associated with the searched feature information are extracted as the package type information corresponding to the feature information in the columns 52, 53, and 54.

“BGA” is an IC package name corresponding to the terminal shape “round.” “QFN” is an IC package name corresponding to the terminal position “inside the closed area,” the terminal shape “rectangle,” and the number of sides “4.” “QFP” is an IC package name corresponding to the terminal shape “rectangle,” the terminal position “outside the closed area,” and the number of sides “4.” “SOP” is an IC package name corresponding to the terminal shape “rectangle,” the terminal position “outside the closed area,” and the number of sides “2.”

Reasons why the IC package names are identified in such a manner based on the above terminal shape, terminal position, and the number of sides are now described.

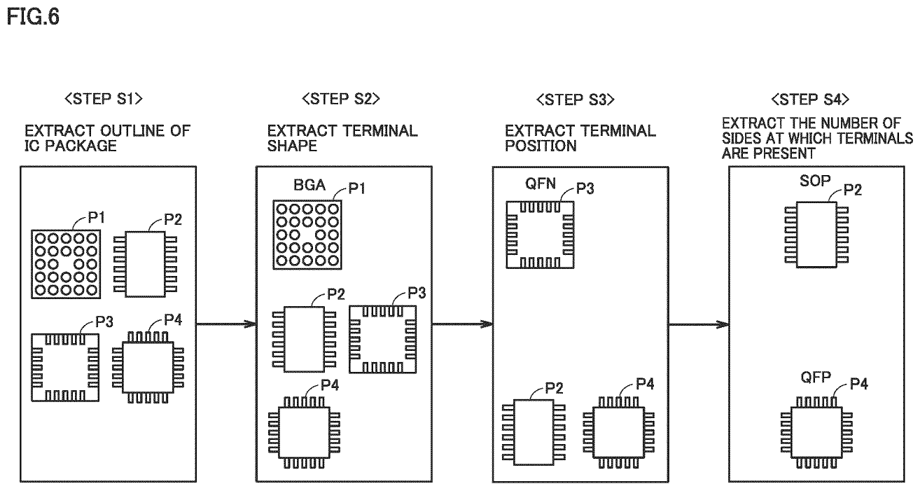

FIG. 6 is a diagram for illustrating a sequence to identifying IC package names. Referring to FIG. 6, in step S1, a rectangular shape having a longest diagonal line is extracted for each of IC packages P1 through P4 as the outline of the IC package, as described with respect to FIG. 3.

In step S2, the terminal shape for each of the IC packages P1 through P4 is extracted. The IC package P1 has a terminal shape “round,” and the IC packages P2 through P4 each have a terminal shape “rectangle.” Therefore, the type of the IC package P1 is identified to be “BGA.”

In step S3, the terminal positions of the IC packages P2 through P4 are extracted. The terminal position of the IC package P3 is “inside the closed area,” and the terminal positions of the IC packages P2 and P4 are “outside the closed area.” Therefore, the type of the IC package P3 is identified to be “QFN.”

In step S4, the number of sides of the package outline, at which the terminals of the IC packages P2 and P4 are present, are extracted. The “the number of sides” for the IC package P2 is “2,” and the “the number of sides” for the IC package P4 is “4.” Therefore, the type of the IC package P2 is identified to be “SOP,” and the type of the IC package P4 is identified to be “QFP.”

### <Pattern Type Determination Scheme>

The design data includes different design constraints for the signal pattern and the power supply pattern. Therefore, the type of interconnect pattern included in the design data needs to be previously identified when performing the design rule checking on the design data.

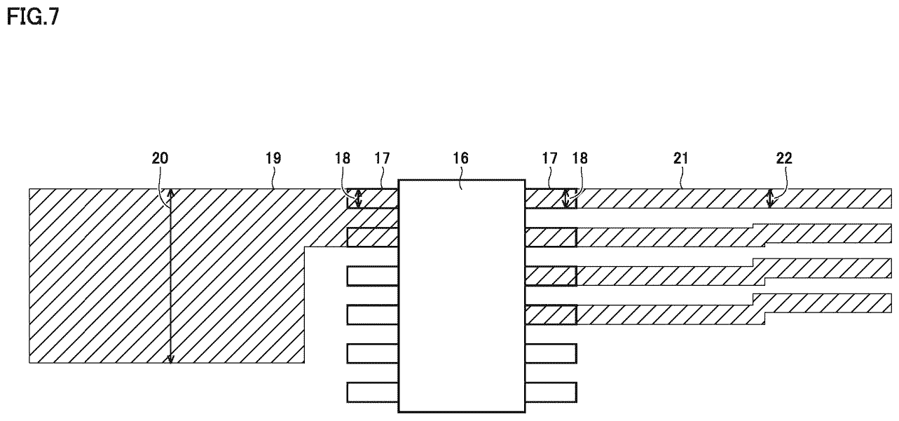

FIG. 7 is a diagram showing one example of the interconnect pattern connected to the terminal of the IC package. Referring to FIG. 7, a power supply pattern 19 and a signal pattern 21 connected to terminals 17 of an IC package 16 are shown.

The power supply pattern 19 and the signal pattern 21 greatly differ in rate of change of the pattern width in the vicinity of the terminals 17 of the IC package 16. Specifically, comparing a terminal dimension 18 and a maximum pattern width 20 of the power supply pattern 19, the maximum pattern width 20 of the power supply pattern 19 is greater than the terminal dimension 18. A maximum pattern width 22 of the signal pattern 21, in contrast, is not much different from the terminal dimension 18 due to the impedance matching of the signal patterned interconnect. In other words, the signal pattern 21 has a smaller ratio of a maximum width of the interconnect pattern connected to the terminals of a IC package to the terminal dimension of the IC package, as compared to the power supply pattern 19.

Moreover, in order to suppress the influence of power supply noise, the impedance value of the power supply pattern 19 is much smaller than the impedance value of the signal pattern 21. In other words, the impedance value of the signal pattern 21 is much larger than the impedance value of the power supply pattern 19.

Accordingly, the power supply pattern and the signal pattern can be categorized based on the ratio of the maximum pattern width to the terminal dimension of the IC package, and the impedance value of the interconnect pattern. Note that the impedance value of the interconnect pattern is calculated by a well-known method, based on the positional relationship between the interconnect pattern geometry and GND, and the layer configuration of the circuit board.

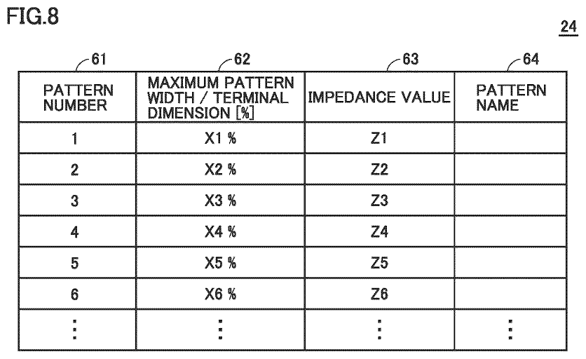

FIG. 8 is a diagram showing one example of an information table of the interconnect pattern. Referring to FIG. 8, in an information table 24, pattern numbers are shown in a column 61. Ratios of the maximum pattern widths of the IC packages included in the electronic circuit board to the terminal dimension are shown in a column 62. Impedance values of the interconnect patterns are shown in a column 63, and pattern names are shown in a column 64.

The ratios in the column 62 and the impedance values in the column 63 correspond to the feature information of the interconnect pattern extracted by the extraction unit 108. The pattern names in the column 64 correspond to the pattern type information determined by the determination unit 110 based on the feature information of the interconnect pattern. Note that the pattern numbers in the column 61 are extracted from the design data 2 (e.g., extracted by reading the text information, etc. described on the CAD data).

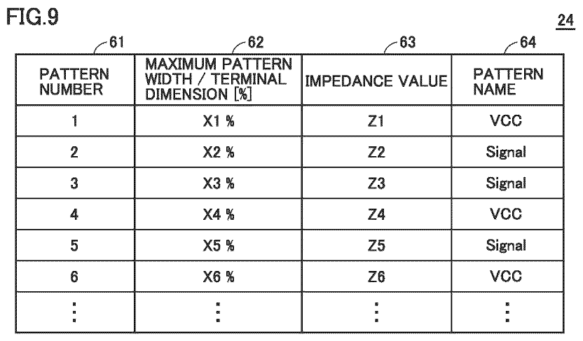

FIG. 9 is a diagram showing an updated version of the information table of the interconnect pattern of FIG. 8. The column 64 in the information table 24 of FIG. 9 is updated from the information table 24 of FIG. 8. Specifically, it can be seen that despite of the column 64 in the information table 24 of FIG. 8 being empty, the pattern names are described in the column 64 of the information table 24 of FIG. 9.

The determination unit 110 determines the pattern names in the column 64, using the table R2 that associates the pattern feature information (e.g., the ratio of a maximum width pattern to the terminal dimension of the IC package, the impedance value of the interconnect pattern) with the pattern type information. Specifically, the determination unit 110 determines the pattern names in the column 64 by comparing the information in the columns 62 and 63 of the information table 24 with the table R2. The table R2 is searched for the same feature information as the feature information in the columns 62 and 63, and the pattern type information that are associated with the feature information are extracted as the pattern type information corresponding to the feature information of the columns 62 and 63.

For example, “VCC” is the pattern name corresponding to a ratio X1 of the maximum pattern width to the terminal dimension and an impedance value Z1, and “Signal’ is the pattern name corresponding to a ratio X2 and an impedance value Z2.

### Advantages Effects

According to Embodiment 1, even if the design data of an electronic circuit board input to the design assistance device includes no information (e.g., the IC package name) indicating the type of an IC package comprising the electronic circuit board and information (e.g., the pattern name) indicating the type of an interconnect pattern, the IC package name and the pattern name can be determined by analyzing the design data. Therefore, appropriate design rule checking can be performed based on design constraints depending on a type of the IC package and a type of the interconnect pattern. In addition, the design burden on a designer can be relieved by showing an appropriate result of the design rule checking on a display or the like.

### Embodiment 2

In Embodiment 2, a configuration is now described in which a machine learning is used to estimate an IC package name and a pattern name. A design assistance device according to Embodiment 2 has the same hardware configuration as Embodiment 1.

### <Functional Configuration>

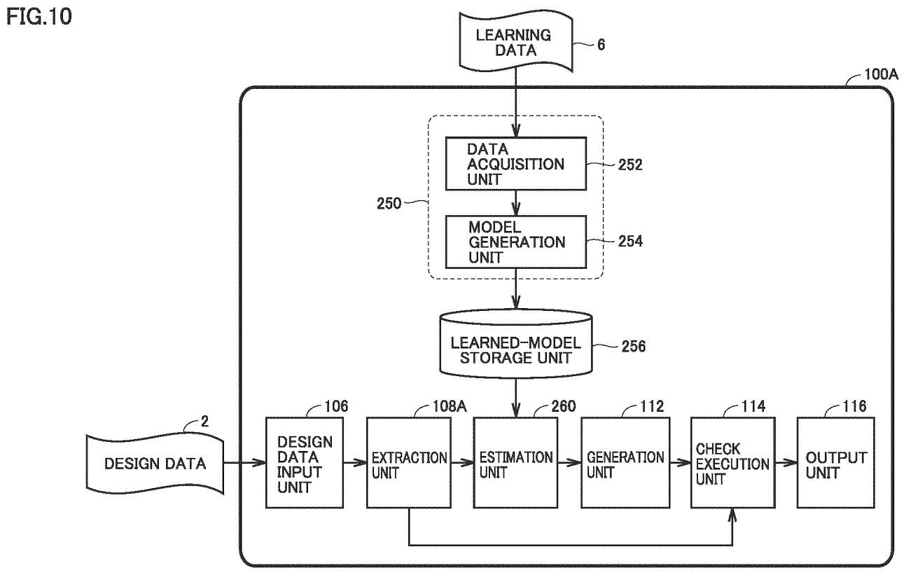

FIG. 10 is a block diagram showing a functional configuration example of the design assistance device according to Embodiment 2. Referring to FIG. 10, a design assistance device 100A includes a design data input unit 106, an extraction unit 108A, a generation unit 112, a check execution unit 114, an output unit 116, a learning unit 250, a learned-model storage unit 256, and an estimation unit 260. The learned-model storage unit 256 is implemented by a primary memory device 152 or a secondary memory device 154. Typically, functions, other than that of the learned-model storage unit 256, are implemented by a processor 150 executing programs, but may be implemented by dedicated hardware circuits.

### (Learning Phase)

A function and process are now described for storing the learned model generated by a machine learning by the learning unit 250 into the learned-model storage unit 256.

The learning unit 250 includes a data acquisition unit 252 and a model generation unit 254. The data acquisition unit 252 obtains learning data 6 (receives an input). The learning data 6 includes learning data L1 and L2.

Specifically, the learning data L1 includes: package feature information which includes the shape of a component comprising an electronic circuit board (e.g., the outline shape of an IC package, the terminal shape of the IC package, and terminal position information); and specification information of the electronic circuit board (e.g., product application of the electronic circuit board, product specifications such as the amount of a current). The learning data L1 is a dataset that associates the package feature information and the specification information with each other.

The learning data L2 includes: the pattern feature information, including the shape of an interconnect pattern comprising the electronic circuit board (e.g., a material of the interconnect pattern, the relative permittivity of the circuit board, the layer configuration of the circuit board, the impedance value of the interconnect pattern, the interconnect pattern geometry, the ratio of the maximum pattern width to the terminal dimension); and the specification information of the electronic circuit board. The learning data L2 is a dataset that associates the package feature information and the specification information with each other.

Using the learning data L1, the model generation unit 254 generates a learned model M1 for estimating the package type information of the IC package comprising the electronic circuit board from the package feature information and the specification information. Using the learning data L2, the model generation unit 254 also generates a learned model M2 for estimating pattern type information of the interconnect pattern comprising the electronic circuit board from the pattern feature information and the specification information.

The learning algorithm used by the model generation unit 254 can be a well-known algorithm such as supervised learning, unsupervised learning, reinforcement learning, etc. In the present embodiment, as one example, a description is given where K-Means method (clustering), which is the unsupervised learning, is applied to the learning algorithm. The unsupervised learning refers to a way of a learning unit learning features included in learning data that includes no result (label) by being provided with the learning data.

The model generation unit 254 learns the package type information by, what is called, unsupervised learning, according to a grouping approach by K-Means clustering, for example.

K-Means clustering is a non-hierarchical clustering algorithm and a way of categorizing given clusters into k clusters using a mean of the clusters.

Specifically, K-Means clustering is processed in the following sequence. Initially, a cluster is randomly assigned to each data xi. Next, a center Vj of each cluster is calculated based on the data assigned to the clusters. Next, the distance between each xi and each Vj is determined, and xi is re-assigned to a cluster whose center is nearest to xi. If the above process does not change the assignment of the clusters to all xi, or if the variation reduces below a pre-set certain threshold, it is determined that the variation has converged, and the process ends.

In the present embodiment, the model generation unit 254 learns the package type information (e.g., the IC package name) by, what is called, unsupervised learning, according to the learning data L1 that is created based on a combination of the package feature information and electronic circuit board specification information obtained by the data acquisition unit 252, and generates the learned model M1. The learned model M1 categorizes the learning data L1 into multiple groups, according to the criteria as follows.

For example, the learned model M1 categorizes a group G1 corresponding to the terminal shape “round” as “BGA,” and a group G2 corresponding to the terminal shape “rectangle” and the terminal position “inside the closed area” as “QFN.” The learned model M1 categorizes a group G3 corresponding to the terminal shape “rectangle,” the terminal position “outside the closed area,” and the number of sides “2” of the IC package outline, at which a terminal is present, as “SON,” and a group G4 corresponding to the terminal shape “rectangle,” the terminal position “outside the closed area,” and the number of sides “4” as “QFP.”

The model generation unit 254 also learns the pattern type information (e.g., the pattern name) by, what is called, unsupervised learning, according to the learning data L2 that is created based on the pattern feature information and electronic circuit board specification information obtained by the data acquisition unit 252, and generates the learned model M2. For example, the learned model M2 categorizes a group H1 corresponding to “the ratio of the maximum pattern width to the terminal dimension is less than a threshold Th” and “the impedance value is greater than or equal to a threshold Tz” as a “signal pattern,” and a group H2 corresponding to “the ratio is greater than or equal to the threshold Th” and “the impedance value is less than the threshold Tz” as a “power supply pattern.”

The model generation unit 254 performs the learning as described above to generate the learned models M1 and M2 for estimating the package type information and the pattern type information from the learning data L1 and L2, and output the learned models M1 and M2 to the learned-model storage unit 256. The learned-model storage unit 256 stores the learned models M1 and M2.

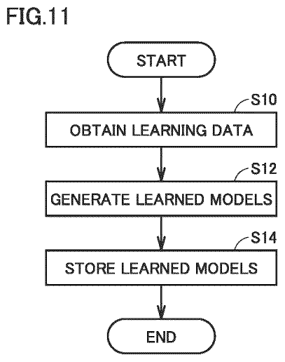

FIG. 11 is a flowchart illustrating one example of a learning process of the design assistance device 100A. The process steps of FIG. 11 are, typically, performed by the processor 150 (the learning unit 250) of the design assistance device 100A.

Referring to FIG. 11, the design assistance device 100A obtains the learning data L1 that includes the package feature information and the specification information, and the learning data L2 that includes the pattern feature information and the specification information (step S10). While a configuration will be described in which the learning data L1 and L2 are obtained simultaneously, the present disclosure is not limited thereto. The design assistance device 100A may obtain the package feature information, the pattern feature information, and the specification information separately, associate the package feature information with the specification information to generate the learning data L1, and associate the pattern feature information with the specification information to generate the learning data L2.

The design assistance device 100A generates the learned model M1 by learning the package type information by the unsupervised learning, according to the obtained learning data L1, and generates the learned model M2 by learning the pattern type information by the unsupervised learning, according to the obtained learning data L2 (step S12).

The design assistance device 100A stores the learned models M1 and M2 into an internal memory (e.g., a secondary memory device 154) (step S14).

### (Utilization Phase)

A sequence to estimating the IC package name and the pattern name using the learned models generated by the machine learning by the learning unit 250 is now described.

Referring to FIG. 10, the design data input unit 106 obtains the design data 2 for a target electronic circuit board on which the design rule checking is to be performed.

Similarly to the extraction unit 108 according to Embodiment 1, the extraction unit 108A determines whether the design data 2 includes type information of a component comprising the target electronic circuit board. If the design data 2 includes no type information, the extraction unit 108A extracts the feature information of the components (e.g., the package feature information and the pattern feature information) and the specification information of the target electronic circuit board.

The estimation unit 260 uses the learned model M1 stored in the learned-model storage unit 256 to estimate the package type information (e.g., the IC package name). Specifically, the estimation unit 260 estimates the package type information by inputting the package feature information and specification information extracted by the extraction unit 108A to the learned model M1.

The estimation unit 260 also uses the learned model M2 stored in the learned-model storage unit 256 to estimate the pattern type information (e.g., the pattern name). Specifically, the estimation unit 260 estimates the pattern type information by inputting the pattern feature information and specification information extracted by the extraction unit 108A to the learned model M2.

The estimation unit 260 outputs the package type information and pattern type information that are estimated in the above manner to the generation unit 112. The functions and processes of the generation unit 112, the check execution unit 114, and the output unit 116 are the same as those described in Embodiment 1, and the description thereof is, therefore, not repeated.

Note that if the extraction unit 108A determines that the design data 2 includes the type information of a component comprising the target electronic circuit board, as with Embodiment 1, the design data 2 obtained by the design data input unit 106 is input to the check execution unit 114. In this case, the process of extraction of the feature information and the specification information by the extraction unit 108, the process of estimation of the type information by the estimation unit 260, and the process of adding the type information to the design data 2 by the generation unit 112 are not performed. Accordingly, the check execution unit 114 performs the design rule checking on the design data 2 obtained by the design data input unit 106.

In the present embodiment, the learned models M1 and M2 learned at the model generation unit 254 are used to output the package type information and the pattern type information. However, the learned models M1 and M2 may be obtained from other devices and the learned models M1 and M2 may be used to output the package type information and the pattern type information.

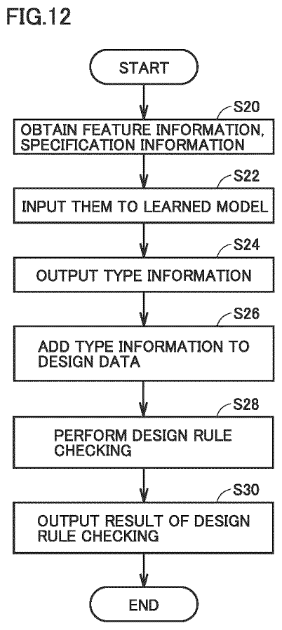

FIG. 12 is a flowchart illustrating one example of process steps performed by the design assistance device 100A. The process steps of FIG. 12 are, typically, performed by the processor 150 of the design assistance device 100A.

Referring to FIG. 12, the design assistance device 100A obtains (extracts) the package feature information, the pattern feature information, and the specification information from the design data 2 (step S20). The design assistance device 100A estimates the package type information by inputting the package feature information and the specification information to the learned model M1, and estimates the pattern type information by inputting the pattern feature information and the specification information to the learned model M2 (step S22).

The design assistance device 100A outputs the estimated package type information and pattern type information (step S24). The design assistance device 100A generates a new design data by adding the package type information and the pattern type information to the design data 2 (step S26). The design assistance device 100A performs the design rule checking on the new design data (step S28). The design assistance device 100A outputs a result of the design rule checking (step S30).

### Advantages Effects

Embodiment 2 has the same advantages effects as Embodiment 1.

### OTHER EMBODIMENTS

(1) In the embodiments described above, if the design assistance device 100 determines that the design data 2 does not include the type information (e.g., the package type information and the pattern type information) of a component comprising the target electronic circuit board, the design assistance device 100 extracts the feature information of the component. However, the present disclosure is not limited thereto. For example, if a user sets the type information to be determined automatically, the design assistance device 100 may extract the feature information of a component without determining whether the design data 2 includes the type information.

(2) In Embodiment 2, the unsupervised learning is applied to the learning algorithm used by the estimation unit 260. However, the present disclosure is not limited thereto. Besides the unsupervised learning, reinforcement learning, supervised learning, or semi-supervised learning is also applicable to the learning algorithm. Deep learning, in which feature extraction itself can be learned, is also used as the learning algorithm used by the model generation unit 254, and the machine learning may be performed according to other well-known method, for example, a neural network, genetic programming, functional and logic programming, a support vector machine, etc.

Not limiting to the non-hierarchical clustering such as K-Means clustering as described above, the unsupervised learning according to Embodiment 2 may be implemented by other well-known method that is capable of clustering, for example, hierarchical clustering such as a nearest neighbor method.

(3) Embodiment 2 has been described with reference to the learning unit 250 and the estimation unit 260 being built in the design assistance device 100A. However, the present disclosure is not limited thereto. The learning unit 250 and the estimation unit 260 may be, for example, separate devices from the design assistance device 100A, which are connected to the design assistance device 100A via a network. In other words, a learning device that includes the learning unit 250, and an estimator device that includes the estimation unit 260 may be provided separately from the design assistance device 100A. In this case, the learning device the estimator device may be present on a cloud server.

(4) In the embodiments described above, the outline dimension of the IC package may be used to vary the thresholds for design rule check items regarding the positional relationships with the peripheral circuit parts (e.g., a bypass capacitor, a resistor, an inductor, etc.) of the IC package.

The package feature information regarding the features of the IC package further includes the outline dimension (e.g., the long-side dimension, the short-side dimension, etc.) of the IC package, in addition to the above-described information. Specifically, by analyzing the design data 2, the extraction unit 108 or the extraction unit 108A further extracts the outline dimension of the IC package as the package feature information, in addition to the outline shape of the IC package, the terminal shape of the IC package, and the terminal position information. In the following, for ease of description, the extraction unit 108 will be representatively described.

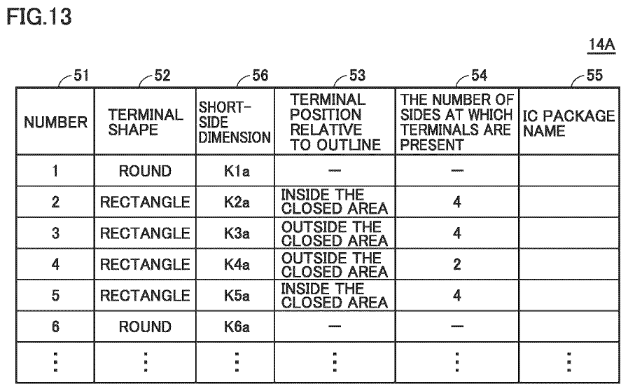

FIG. 13 is a diagram showing one example of information table for an IC package according to other embodiment. Referring to FIG. 13, an information table 14A is the information table 14 of FIG. 4 with the addition of a column 56.

The column 56 shows short-side dimensions of IC packages. The short-side dimension is extracted by the extraction unit 108 as feature information of the IC package. In the example of FIG. 13, the short-side dimensions of the IC packages having the part numbers 1 to 6 are K1a to K6a, respectively.

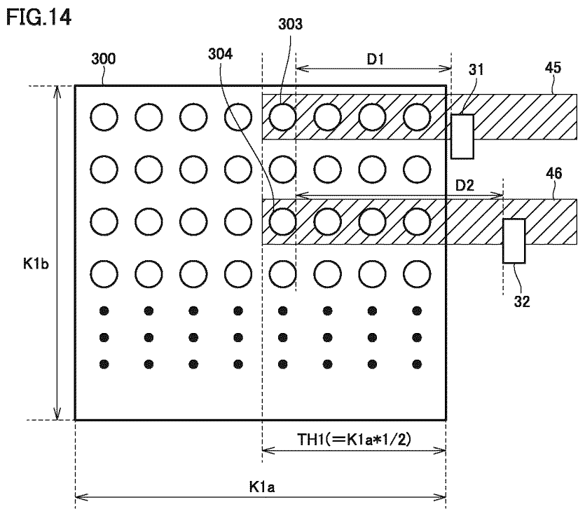

FIG. 14 is a diagram for illustrating positional relationships between the IC package and peripheral circuit parts. Referring to FIG. 14, an IC package 300 is an IC package (e.g., BGA) which has terminals arranged in a grid pattern. The IC package 300 is, for example, provided with multiple power supply terminals (power pins) 303 and 304. The short-side dimension of the IC package 300 is “K1a,” and the long-side dimension is “K1b.”

Assume that a power supply terminal and a peripheral circuit part of the IC package 300 are interconnected. In the example of FIG. 14, the power supply terminal 303 and a peripheral circuit part 31 are connected together via an interconnect pattern 45, and the power supply terminal 304 and a peripheral circuit part 32 are connected together via an interconnect pattern 46.

Here, assume that the peripheral circuit parts 31 and 32 are filter circuits such as bypass capacitors. From the standpoint of noise measures, it is preferable that a filter circuit is disposed immediately adjacent to the power supply terminal. In the IC package in which terminals are disposed in a grid pattern represented by BGA, column grid array (CGA), land grid array (LGA), the rear surface of the IC package may not be utilized due to constrains on pulling wires. In this case, the filter circuit is disposed on the same surface (same layer) as the IC package.

When the IC package and the filter circuit are disposed on the same layer, it is preferable, from the above standpoint of noise measures, that they are disposed as close to each other as possible. However, the shortest path length between the power supply terminal and the filter circuit depends on an outline dimension of the IC package. Specifically, a terminal (e.g., the power supply terminals 303 and 304) that is located at the center of the IC package has a greatest, shortest path length with the filter circuit. Therefore, the shortest path length between a filter circuit that is disposed close to the outline of the IC package and the terminal located at the center of the IC package is approximately half the short-side dimension of the IC package.

This suggests that a threshold TH1 for a check item (e.g., a check item regarding the positional relationship between a peripheral circuit part and the IC package) during the design rule checking performed by the check execution unit 114 using the short-side dimension of the IC package can be changed to an appropriate value. The threshold TH1 is, for example, set to half the short-side dimension K1a of the IC package 300. If the shortest path length between the terminals of the IC package 300 and the peripheral circuit parts is less than the threshold TH1, the check execution unit 114 determines that the criteria is met (i.e., the power supply terminal and the peripheral circuit part are in close distance, which is appropriate). If the shortest path length is greater than or equal to the threshold TH1, in contrast, the check execution unit 114 determines that the criteria is not met (i.e., the power supply terminal and the peripheral circuit part are far apart, which is inappropriate).

In the example of FIG. 14, the shortest path length between the peripheral circuit part 31 and the power supply terminal 303 is “D1.” Since the shortest path length D1 is less than the threshold TH1, the check execution unit 114 determines that the positional relationship between the peripheral circuit part 31 and the power supply terminal 303 is appropriate. The shortest path length between the peripheral circuit part 32 and the power supply terminal 304 is “D2.” Since the shortest path length D2 is greater than or equal to the threshold TH1, the check execution unit 114 determines that the positional relationship between the peripheral circuit part 32 and the power supply terminal 304 is inappropriate, and outputs an error.

Subsequently, a sequence is described from an input to the design data 2 to performing the design rule checking by the check execution unit 114 using a new threshold TH1.

The design data input unit 106 receives an input to the design data 2 for the target electronic circuit board. By analyzing the design data 2, the extraction unit 108 extracts the feature information which includes the shape of a component comprising the target electronic circuit board.

The extraction unit 108 extracts the package feature information of the IC package, and the information table 14A, as shown in FIG. 13, is created. If the design data 2 does not include the package type information, after the processing described above by the determination unit 110 and the generation unit 112, the information table 14A having IC package names entered in the column 55 of the information table 14A of FIG. 13 is created. In other words, the column 55 of the information table 14A is updated, as shown in FIG. 5. For example, “BGA” is entered as an IC package name corresponding to the part number 1.

If the design data 2 includes the package type information, in contrast, the information table 14A, having IC package names entered in the column 55 based on the package type information extracted by the extraction unit 108, is created.

Note that the extraction unit 108 also extracts information on shapes (e.g., the outline shape, the outline dimension, etc.) and types of the peripheral circuit parts.

The check execution unit 114 calculates the threshold TH1 for checking the positional relationship between the IC package and a peripheral circuit part based on the outline dimension. Specifically, the check execution unit 114 refers to the updated information table 14A and calculates the threshold TH1 for the IC package having terminals arranged in a grid pattern, based on the short-side dimension. For example, since the IC package corresponding to the part number 1 is “BGA,” the threshold TH1 for checking the positional relationship between the IC package and the peripheral circuit part is calculated to be “K1a×½.”

The check execution unit 114 changes the default threshold to the threshold TH1, and, using the threshold TH1, performs the design rule checking regarding the positional relationship between the IC package and the peripheral circuit part.

Since the threshold that is used for the design rule checking is automatically changed to an appropriate value in this manner, configuration tasks by a user can be assisted. Note that, in the configuration settings of the design assistance device 100, the user can also change the way of calculation of the threshold TH1 or the value of the threshold TH1 prior to the performance of the design rule checking.

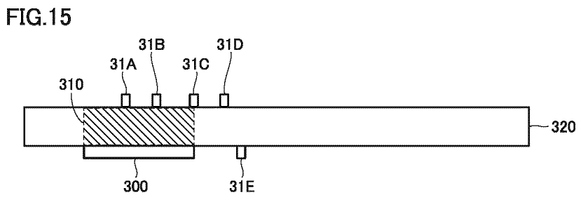

FIG. 15 is a diagram for illustrating a mode of application of a threshold during the design rule checking. Referring to FIG. 15, the IC package 300 (e.g., BGA) having terminals arranged in a grid pattern and peripheral circuit parts 31A to 31E are mounted on an electronic circuit board 320. Here, the terminals of the IC package 300 and the peripheral circuit parts 31A to 31E are connected to each other via an interconnect pattern.

Among the peripheral circuit parts 31A to 31E, the check execution unit 114 determines, by a graphics operation process, the peripheral circuit part that is located fully in an internal region 310 inside the outline of the IC package 300, and the peripheral circuit part that is located fully on the outline of the IC package 300 or in an outer region outside the outline. In the example of FIG. 15, the peripheral circuit parts 31A and 31B are determined to be located fully inside the internal region 310. The peripheral circuit part 31C is determined to be located on the outline, and the peripheral circuit parts 31D and 31E are determined to be located fully in the outer region outside the outline.

The check execution unit 114 applies the threshold TH1 as a threshold for checking the positional relationships between the peripheral circuit parts 31C through 31E and the IC package 300. Specifically, the check execution unit 114 determines whether the shortest path length between each of the peripheral circuit parts 31C through 31E and a terminal (e.g., a power supply terminal) of the IC package 300 is less than the threshold TH1. Note that the shortest path length between a terminal of the IC package 300 and a peripheral circuit part (e.g., the peripheral circuit parts 31C and 31D) that is disposed on a layer different from the surface (layer) having the IC package 300 mounted thereon is the total distance obtained by connecting the interconnect pattern and VIA connecting both the layers.

A predetermined value different from the threshold TH1 is applied to the threshold for checking the positional relationship between the IC package 300 and the peripheral circuit parts 31A and 31B located in the internal region 310.

Here, assume that another threshold TH2 (e.g., K1a×⅓, K1a×¼) that is less than the threshold TH1 (e.g., K1a×½) is used to check the positional relationship between a peripheral circuit part that has to be disposed on the same layer as the IC package 300 and a terminal (hereinafter, also referred to as a “center terminal”) that is located at the center of the IC package 300. However, due to the constraints of the outline dimension of the IC package 300, reducing the shortest path length between the peripheral circuit part and the center terminal less than “K1a×½” is not production feasible. Therefore, the threshold TH2 is inappropriate as a threshold for checking the above positional relationship.

According to the above configuration, the threshold TH1 based on the short-side dimension can be used to perform the design rule checking. Thus, a spurious error caused by performing the design rule checking using an inappropriate threshold (e.g., the threshold TH2) can be inhibited.

(5) The configurations exemplified as the above-described embodiments are one example configuration of the present disclosure, and can be combined with other known technique, or can be modified, such as part of the configuration being omitted, without departing from the gist of the present disclosure. Moreover, in the above-described embodiments, the processes and configurations described in the other embodiments may be appropriately adapted and implemented.

The presently disclosed embodiments should be considered in all aspects as illustrative and not restrictive. The scope of the present disclosure is indicated by the appended claims, rather than by the description above, and all changes that come within the scope of the claims and the meaning and range of equivalency of the claims are intended to be embraced within their scope.

### REFERENCE SIGNS LIST

2 design data; 4 element data; 6 learning data; 12 outline; 13, 17 terminal; 14, 14A, 24 information table; 18 terminal dimension; 19 power supply pattern; 20, 22 maximum pattern width; 21 signal pattern; 31, 32 peripheral circuit part; 45, 46 interconnect pattern; 100, 100A design assistance device; 102, 252 data acquisition unit; 104 database unit; 106 design data input unit; 108, 108A extraction unit; 110 determination unit; 112 generation unit; 114 check execution unit; 116 output unit; 150 processor; 152 primary memory device; 154 secondary memory device; 156 communications interface; 158 input device; 160 display; 162 internal bus; 250 learning unit; 254 model generation unit; 256 learned-model storage unit; 260 estimation unit; 303, 304 power supply terminal; and 320 electronic circuit board.

1. A design assistance device, comprising:
a database unit to store reference information associating feature information which includes a shape of a component comprising an electronic circuit board with type information of the component;
a data input unit to receive an input of design data of a target electronic circuit board to be subjected to design rule checking;
an extraction unit to extract feature information which includes shape information of a component comprising the target electronic circuit board by analyzing the design data;
a determination unit to determine type information, corresponding to the extracted feature information, of the component comprising the target electronic circuit board, based on the extracted feature information and the reference information stored in the database unit;
a generation unit to generate new design data by adding the type information determined by the determination unit to the design data; and
an execution unit to perform, on the new design data, the design rule checking depending on the type information included in the new design data.

2. The design assistance device according to claim 1, wherein
when the design data does not include the type information of the component comprising the target electronic circuit board, the extraction unit extracts the feature information of the component comprising the target electronic circuit board.

3. The design assistance device according to claim 1, wherein
the feature information of the component includes feature information of an integrated circuit package, and
as the feature information of the integrated circuit package included in the target electronic circuit board, the extraction unit extracts an outline shape of the integrated circuit package, a terminal shape of the integrated circuit package, and information indicating a positional relationship between an outline of the integrated circuit package and a terminal of the integrated circuit package.

4. The design assistance device according to claim 3, wherein
the type information corresponding to the extracted feature information of the integrated circuit package includes a type of the integrated circuit package.

5. The design assistance device according to claim 1, wherein
the feature information of the component includes feature information of an interconnect pattern, and
as the feature information of the interconnect pattern included in the target electronic circuit board, the extraction unit extracts an impedance value of the interconnect pattern, and a ratio of a maximum width of the interconnect pattern connected to the terminal of the integrated circuit package to a terminal dimension of the integrated circuit package included in the target electronic circuit board.

6. The design assistance device according to claim 5, wherein
the type information corresponding to the extracted feature information of the interconnect pattern includes a type of the interconnect pattern.

7. The design assistance device according to claim 4, wherein
as the feature information of the integrated circuit package included in the target electronic circuit board, the extraction unit further extracts information indicating an outline dimension of the integrated circuit package,
based on the outline dimension, the execution unit calculates a threshold for checking a positional relationship between the integrated circuit package and a peripheral circuit part included in the target electronic circuit board, and
the execution unit uses the threshold to perform the design rule checking on the new design data.

8. The design assistance device according to claim 7, wherein
the threshold is a threshold for checking the positional relationship between the integrated circuit package and the peripheral circuit part that is located on the outline of the integrated circuit package or in an outer region outside the outline.

9. The design assistance device according to claim 7, wherein
the integrated circuit package is an integrated circuit package which has terminals disposed in a grid pattern.

10. A learning device, comprising:
a data acquisition unit to obtain learning data which includes: feature information which includes a shape of a component comprising an electronic circuit board; and specification information of the electronic circuit board; and
a model generation unit to generate, using the learning data, a learned model for estimating type information of the component comprising the electronic circuit board from the feature information and the specification information.

11. The learning device according to claim 10, wherein
the feature information of the component includes feature information of an integrated circuit package, and
the type information corresponding to the feature information of the integrated circuit package includes a type of the integrated circuit package.

12. The learning device according to claim 10, wherein
the feature information of the component includes feature information of an interconnect pattern, and
the type information corresponding to the feature information of the interconnect pattern includes a type of the interconnect pattern.

13. A design assistance device, comprising:
a data input unit to receive an input of design data of a target electronic circuit board to be subjected to design rule checking;
an extraction unit to extract feature information which includes a shape of a component comprising the target electronic circuit board, and specification information of the target electronic circuit board, by analyzing the design data; and
an estimation unit to estimate type information of the component by inputting the feature information and the specification information extracted by the extraction unit to a learned model for estimating the type information from the feature information and the specification information.

14. The design assistance device according to claim 13, wherein
the feature information of the component includes feature information of an integrated circuit package, and
the type information corresponding to the feature information of the integrated circuit package includes a type of the integrated circuit package.

15. The design assistance device according to claim 13, wherein
the feature information of the component includes feature information of an interconnect pattern; and
the type information corresponding to the feature information of the interconnect pattern includes a type of the interconnect pattern.

16. The design assistance device according to claim 7, wherein
the threshold is a first threshold for checking the positional relationship between the integrated circuit package and the peripheral circuit part that is located on the outline of the integrated circuit package or in an outer region outside the outline, or a second threshold for checking the positional relationship between the integrated circuit package and the peripheral circuit part located in an internal region inside the outline of the integrated circuit package, and
the first threshold differs from the second threshold.

17. A non-transitory computer readable storage medium storing a learned model generated by the learning device according to claim 10, wherein
the learned model causes a computer to function so that when feature information which includes a shape of a component comprising an electronic circuit board and specification information of the electronic circuit board are input to the learned model, the learned model outputs type information of the component, the learned model having been machine-learned using learning data including the feature information and the specification information.
